(19) United States
(12) Patent Application Publication
(10) Pub. No.: US 2026/0134197 A1
(43) Pub. Date: May 14, 2026

(54) PROMPT MANAGEMENT

(71) Applicant: Beijing Zitiao Network Technology Co., Ltd., Beijing (CN)

(72) Inventors: Hui YAO, Beijing (CN); Qinghong CHEN, Beijing (CN); Yiran PENG, Beijing (CN); Zhenfei HAO, Beijing (CN); Chengwu LI, Beijing (CN)

(21) Appl. No.: 19/185,329

(22) Filed: Apr. 22, 2025

(30) Foreign Application Priority Data
Nov. 11, 2024 (CN) 202411605436.3

(51) Int. Cl. G06F 40/166; G06F 16/3329

(52) U.S. Cl. CPC G06F 40/166; G06F 16/3329

(57) ABSTRACT

Embodiments of the disclosure provide a method, an apparatus, a device, a storage medium and a program product for prompt management. An example method includes: in response to a resource creation request of a prompt, providing a creation interface for prompt creation; receiving, via the creation interface, a target prompt created using the creation interface and identification information of the target prompt; and in response to a confirmation indication, adding the received target prompt and the identification information into a prompt library, the prompt library including at least one prompt, each of the at least one prompt being selectable to be associated with a function based on a machine learning model, and the associated prompt being provided as an input of the machine learning model.

### CROSS-REFERENCE

The present application claims priority to Chinese Patent Application No. 202411605436.3, filed on Nov. 11, 2024 and entitled “METHOD, APPARATUS, DEVICE, STORAGE MEDIUM AND PROGRAM PRODUCT FOR PROMPT MANAGEMENT”, the entirety of which is incorporated herein by reference.

### FIELD

Example embodiments of the present disclosure generally relate to the field of computers, and in particular, to a method, an apparatus, a device, a computer-readable storage medium, and a computer program product for prompt management.

### BACKGROUND

With the rapid development of computer technology, the application of machine learning models is also increasing, wherein the prompt is a key tool for interacting with a machine learning model. A precise prompt is not only the key for optimizing the generation task, but also the core for determining the quality of output of the machine learning model. For example, an assistant based on a machine learning model can understand and reply to the interaction messages inputted by the user in a natural language manner based on a machine learning model. Therefore, a high-quality prompt can significantly improve the understanding depth on the task of the machine learning model, thereby pushing the generation of high-quality content.

### SUMMARY

In the first aspect of the present disclosure, a method for prompt management is provided. The method comprises: in response to a resource creation request of a prompt, providing a creation interface for prompt creation; receiving, via the creation interface, a created target prompt and identification information of the target prompt; and in response to a confirmation indication, adding the received target prompt and the identification information into a prompt library, the prompt library comprising at least one prompt, each prompt being selectable to be associated with a function based on a machine learning model, and the associated prompt being provided as an input of the machine learning model.

In a second aspect of the present disclosure, an apparatus for prompt management is provided. The device comprises a creation interface providing module, configured to provide, in response to a resource creation request of a prompt, a creation interface for prompt creation; a receiving module, configured to receive, via the creation interface, a created target prompt and an identification information of the target prompt; and an adding module, configured to add, in response to a confirmation indication, the received target prompt and the identification information into a prompt library, the prompt library comprising at least one prompt, each prompt being selectable to be associated with a function based on a machine learning model, and the associated prompt being provided as an input of the machine learning model.

In a third aspect of the present disclosure, an electronic device is provided. The apparatus includes at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium is provided. The computer-readable storage medium stores a computer program, and the computer program is executable by the processor to implement the method of the first aspect.

In a fifth aspect of the present disclosure, a computer program product is provided. The computer program product comprises computer executable instructions. The computer executable instructions, when executed by a processor, implement the method of the first aspect.

It should be understood that the content described in this section is not intended to limit the key features or important features of the embodiments of the present disclosure, nor intended to limit the scope of the present disclosure. Other features of the present disclosure will become understandable from the following description.

### BRIEF DESCRIPTION OF DRAWINGS

The above and other features, advantages, and aspects of various embodiments of the present disclosure will become more apparent with the reference of the following detailed description in conjunction with the accompanying drawings. In the drawings, the same or similar reference numbers refer to the same or similar elements, wherein:

FIG. 1 shows a schematic diagram of an example environment in which embodiments of the present disclosure can be implemented;

FIGS. 2A-2G show schematic diagrams of example interfaces for prompt management according to some embodiments of the present disclosure;

FIGS. 3A-6 show schematic diagrams of example interfaces for creating a new prompt or editing a specific function according to some embodiments of the present disclosure;

FIGS. 7A-7E show schematic diagrams of example interfaces for a comment function for a prompt according to some embodiments of the present disclosure;

FIG. 8 shows a flowchart of a process for prompt management according to some embodiments of the present disclosure;

FIG. 9 shows a schematic structural block diagram of an apparatus for prompt management according to some embodiments of the present disclosure; and

FIG. 10 shows a block diagram of an electronic device in which one or more embodiments of the present disclosure may be implemented.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be comprised below.

Herein, unless explicitly stated, “in response to A” performing one step does not imply that this step is performed immediately after “A”, but may comprise one or more intermediate steps.

It may be understood that the data involved in the technical solution (including but not limited to the data itself, the obtaining or using of the data) should follow the requirements of the corresponding laws and regulations and related rules.

It may be understood that before using the technical solutions disclosed in the embodiments of the disclosure, the relevant users should be informed of the types, use ranges, usage scenario, and the like of the personal information related to the present disclosure in an appropriate manner according to relevant laws and regulations and the authorization of the relevant users may be obtained. Wherein, the relevant users may comprise any type of subjects of rights, such as individuals, enterprises, and groups.

For example, in response to receiving an active request from a user, prompt information is sent to the relevant user to explicitly prompt the relevant user that the requested operations to be performed would require acquisition and use of personal information of the relevant user, such that the relevant user may autonomously select whether to provide personal information to software or hardware such as an electronic device, an application, a server, or a storage medium that performs the operations of the technical solution of the disclosure, according to the prompt information.

As an optional but non-limiting implementation, in response to receiving an active request from the relevant user, a manner of sending prompt information to the relevant user may be, for example, a pop-up window, and the pop-up window may present the prompt information in a text manner. In addition, the pop-up window may further carry a selection control for the user to select “agree” or “disagree” to provide personal information to the electronic device.

It may be understood that the foregoing process of notifying and acquiring users' authorization is merely illustrative, and does not constitute a limitation on the implementations of the disclosure, and other manners that meet related laws and regulations may also be applied to the implementations of the disclosure.

As used herein, the term “model” may learn associations between corresponding inputs and outputs from training data, such that after training is complete, a corresponding output may be generated for a given input. The generation of the model may be based on a machine learning technique. Deep Learning is a machine learning algorithm that processes inputs and provides corresponding outputs by using a multi-layer processing unit. A neural network is an example of a model that based on Deep Learning. The “model” may also be referred to herein as “machine learning model”, “learning model”, “machine learning network”, or “learning network”. These terms are used interchangeably herein.

As briefly described above, the digital assistant is able to understand and reply to the interaction messages inputted by the user in a natural language manner based on a machine learning model. The digital assistant may be used as a tool for effective work, learning and life of people. In general, the development of digital assistants is similar to the development of general applications, requiring developers with programming capabilities to define various capabilities of digital assistants by writing complex code, and to deploy digital assistants on appropriate running platforms for users to download, install, and use digital assistants.

As application scenarios diversify and the availability of machine learning technologies become more and more powerful, it is expected that more functions (for example, digital assistants or workflow nodes) based on machine learning models with different capabilities can be developed to support task processing in various fields, or meet personalized demands of different users. The user may determine a different digital assistant or workflow node by creating different prompts and providing the prompts to the machine learning model to utilize the machine learning model. Conventionally, users often need to manually write different prompts to create digital assistants or workflow nodes with different functions. However, when the user desires to create a digital assistant or workflow node with different functions, the user needs to re-write the prompt.

According to an embodiment of the present disclosure, an improved solution for prompt management is provided. According to the solution, if a resource creation request for a prompt is received, a creation page for prompt creation is provided. Correspondingly, the created target prompt and the identification information of the target prompt are received via the creation interface. If the confirmation indication is received, the received target prompt and the identification information of the received target prompt are added to the prompt library. The prompt library comprises at least one prompt, each prompt being selectable to be associated with a function based on a machine learning model, and the associated prompt being provided as an input of the machine learning model. In the embodiment of the present disclosure, the prompt management may include, but is not limited to, creating a prompt as a resource, editing a prompt resource, applying a prompt resource, and the like.

Thereby, the embodiments of the present disclosure, enable the user to conveniently and quickly reuse or continue to modify the prompt via storing the prompt in the prompt library. This can help quickly create a digital assistant based on a machine learning model or workflow node with different functions.

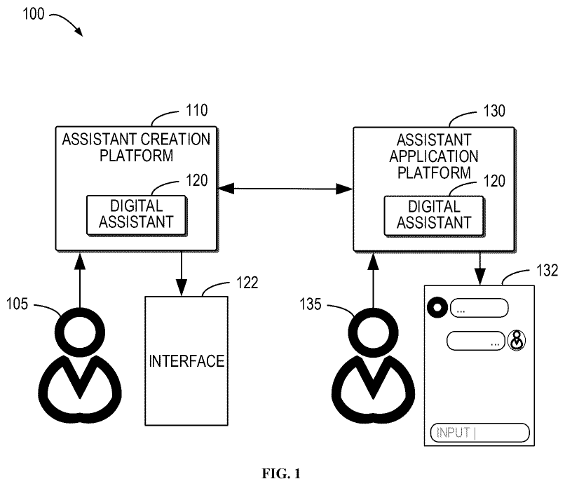

FIG. 1 shows a schematic diagram of an example environment 100 in which the embodiments of the present disclosure can be implemented. The environment 100 relates to an assistant creation platform 110 and an assistant application platform 130.

As shown in FIG. 1, the assistant creation platform 110 may provide a user 105 with a creation and publishing environment of a digital assistant or workflow node. In some embodiments, assistant creation platform 110 may be a low code platform that provides a collection of tools created by a digital assistant or workflow node. The assistant creation platform 110 may support a visual development of the digital assistant or workflow node, so that the developer can skip the process of manual encoding and accelerate the development cycle and cost of the application. Assistant creation platform 110 may support any suitable platform for users to develop digital assistants and other types of applications, any suitable platform may comprise such as an Application Platform as a Service (aPaaS) based platform. Such a platform can support users to efficiently develop applications, and implement operations such as application creation and application function adjustment.

The assistant creation platform 110 may be deployed locally on a terminal device of the user 105 and/or may be supported by a remote server. For example, the terminal device of the user 105 may run a client with the assistant creation platform 110, and the client may support user to interact with the assistant creation platform 110. In the case that the assistant creation platform 110 runs locally on the terminal device of the user, the user 105 may directly interact with the local assistant creation platform 110 by using the client. In the case that the assistant creation platform 110 runs on the server device, the server device may implement, based on the communication connection with the terminal device, the service to the client running in the terminal device. The assistant creation platform 110 may present a respective interface 122 to the user 105 based on the operation of the user 105 to output information to the user 105 and/or receive information from the user 105.

In some embodiments, the assistant creation platform 110 may be associated with a respective database, in which data or information needed for the digital assistant creation process based on a machine learning model is stored. The digital assistant creation process is supported by the assistant creation platform 110. For example, the database may store the corresponding codes and description information for function modules constituting the digital assistant. The assistant creation platform 110 may also perform operations such as calling, adding, deleting, updating, and the like on functional modules in the database. The database may also store operations that may be performed on different functional blocks. For example, in a scenario in which a digital assistant is to be created, the assistant creation platform 110 may call a corresponding function block from a database to build a digital assistant. Such modules may include, but are not limited to, plug-ins, workflows (workflows may consist of a series of workflow nodes with sequential execution order and dependencies), knowledge library, and the like for implementing specific functions.

In the embodiments of the present disclosure, the user 105 may create a digital assistant 120 as needed on the assistant creation platform 110 and publish the digital assistant 120. The digital assistant 120 may be published to any suitable assistant application platform 130 so long as assistant application platform 130 is capable of supporting the operation of digital assistant 120. After the publishing, the digital assistant 120 may be used for a dialogue interaction with the user 135. A client of the assistant application platform 130 may present, in a client interface, an interaction window 132, such as a conversation window, of the digital assistant 120. The digital assistant 120, as an intelligent assistant, has intelligent dialogue and information processing capabilities. The user 135 may input a conversation message in a conversation window, and the digital assistant 120 may determine, based on the created configuration information, a reply message and present it to the user in the interaction window 132. In some embodiments, depending on the configuration of the digital assistant 120, the interaction message with the digital assistant 120 may comprise a message in multi-modal form, such as a text message (e.g., natural language text), a voice message, an image message, a video message, etc.

The assistant creation platform 110 and/or the assistant application platform 130 may run on suitable electronic devices. The electronic device herein may be any type of device with compute capability, comprise terminal device and server device. The terminal device may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the assistant creation platform 110 and/or assistant application platform 130 may be implemented based on cloud services.

It should be understood that the structure and function of the environment 100 is described for exemplary purposes only and does not imply any limitation to the scope of the present disclosure. For example, while FIG. 1 shows a single user interacting with the assistant creation platform 110 and a single user interacting with the assistant application platform 130, in practice multiple users may access the assistant creation platform 110 to create a digital assistant respectively, and each digital assistant may be used to interact with the multiple users.

Some example embodiments of the present disclosure will be described in detail below with reference to examples of the accompanying drawings. It should be understood that the pages/interfaces shown in the figures are merely examples, and various page designs/interfaces designs may actually exist. Each graphical elements in a page/interface may have different arrangements and different visual representations. one or more elements may be omitted or replaced, and one or more other elements may also be present. Embodiments of the present disclosure are not limited in this respect.

The method for prompt management described in the embodiments of the present disclosure may be implemented on an assistant creation platform, a terminal device on which the assistant creation platform is installed, and/or a server corresponding to the assistant creation platform. In the following examples, for discussion demand, the present disclosure will be described from perspective of the assistant creation platform, such as the assistant creation platform 110 shown in FIG. 1. The interface presented by the assistant creation platform 110 may be presented via a terminal device of user 105 and may receive the input of the user via a terminal device of user 105. Herein, the user 105 creating a digital assistant is also sometimes referred to an assistant creator, an assistant developer, or the like.

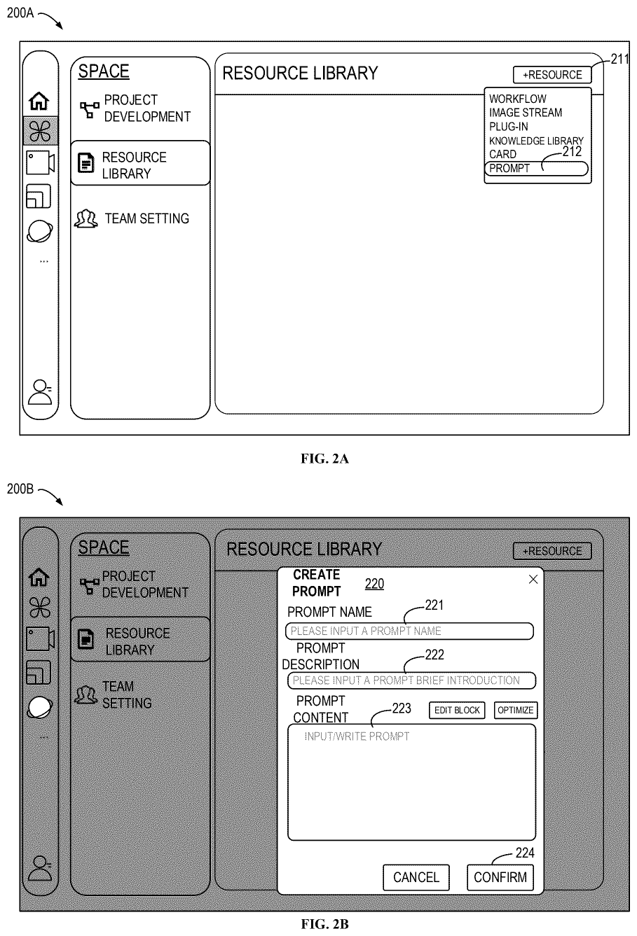

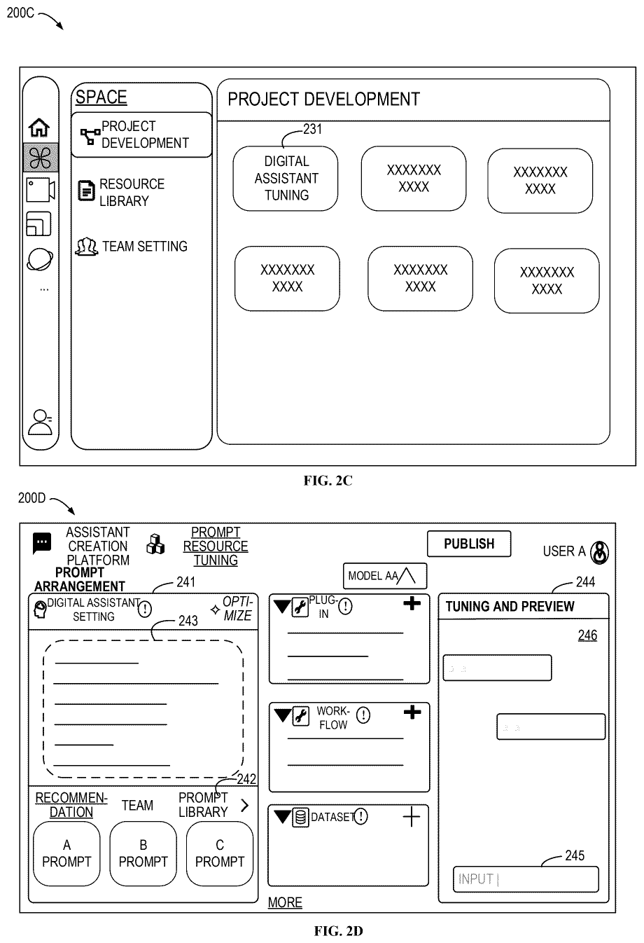

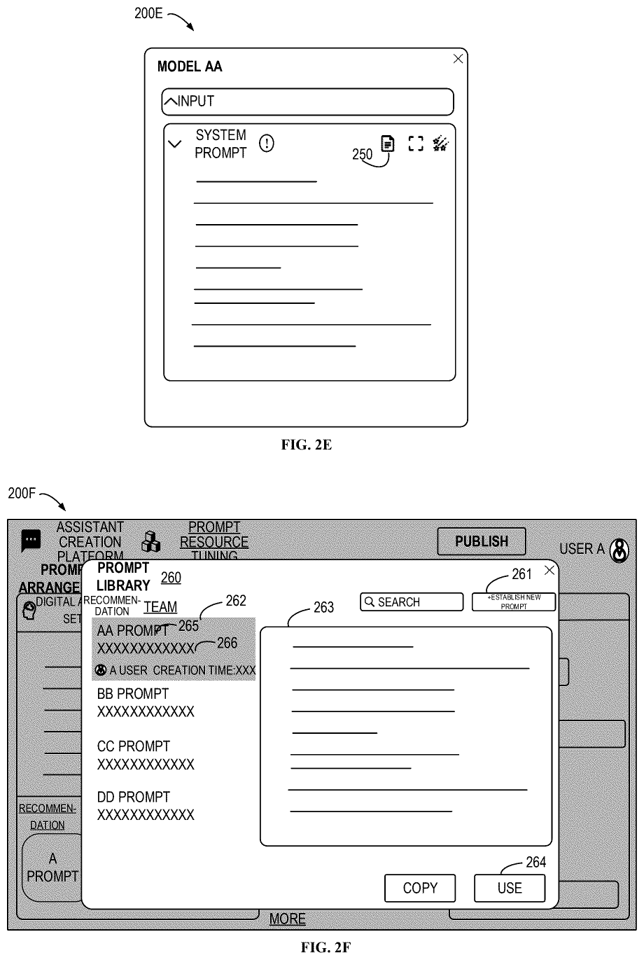

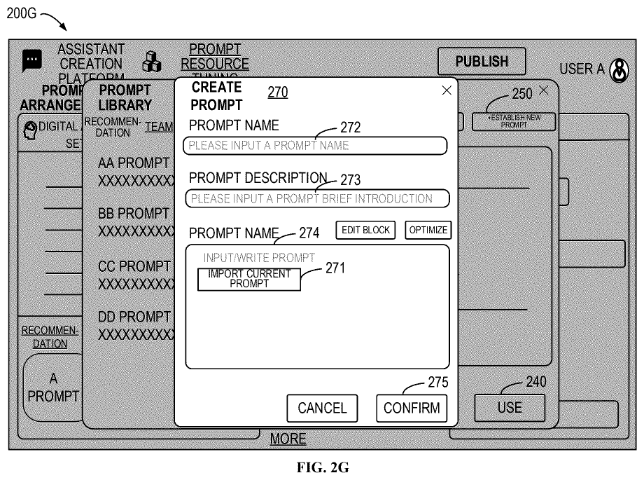

For ease of understanding, the following description will be illustrated refer to the accompanying drawings and mainly an example where the prompt are associated with a digital assistant based on a machine learning model. However, this is merely exemplary, and not limited in the present disclosure. For example, each prompt may also be associated with a workflow or workflow node based on a machine learning model. The method for prompt management according to the present disclosure will be described below with reference to FIGS. 2A-2G. FIGS. 2A-2G show schematic diagrams of example interfaces 200A-200G for prompt management according to some embodiments of the present disclosure. It should be understood that the user may create a prompt, and save the prompt in the prompt library as a resource. The user may also edit the prompt resource. Additionally, the user may also apply the prompt resources created by himself/herself or other users.

In an embodiment of the present disclosure, if the assistant creation platform 110 receive a resource creation request for a prompt, a creation interface for prompt creation is provided. In some embodiments, the assistant creation platform 110 may provide, in a resource addition interface, an addition of a prompt resource type. In the case of receiving the selection on the prompt resource type, the assistant creation platform 110 may receive a resource creation request for the prompt. As the example interfaces 200A to 200B shown in FIG. 2A to FIG. 2B, if the assistant creation platform 110 detects that the user 105 clicks the “prompt” control 212 in the panel corresponding to the “create resource” 211, a creation interface 220 shown in FIG. 2B for prompt creation is presented. In this way, on the assistant creation platform of the digital assistant, the prompt may be considered as a resource similar to other resources (e.g., workflow, image stream, plug-in, knowledge library, message card, etc.), and may be shared to other users for use.

In some embodiments, the assistant creation platform 110 may also receive, in an editing interface editing a specific function, a resource creation request for a prompt. The function herein refers to a function based on a machine learning model. In a conventional function editing scenario, because the function is to be implemented based on a machine learning model, the creator also needs to input a prompt (for example, a system prompt) of the machine learning model when the function is edited. One example of such functionality comprises an AI application, such as a digital assistant, for interacting with a user, where the digital assistant's reply to the user is generated based on a creator specified machine learning model. In some examples, for a digital assistant based on a machine learning model, in a scenario in which the digital assistant interacts with the user A, if an input of the user A is received, a prompt to be input to the machine learning model associated with the digital assistant may be determined based on the input of the user A and the system prompt. The machine learning model may determine a model output based on the inputted prompt. The output will be used to determine a reply to user A.

Another example of a function based on a machine learning model is a workflow node in a workflow. In the editing of the workflow, one or more workflow nodes are selectable as workflow nodes based on a machine learning model. The workflow nodes are configured to process inputs of the workflow nodes with a machine learning model to obtain outputs of the workflow node. It should be understood that, in addition to digital assistants or workflow nodes, other types of functions based on a machine learning model may also exist. For those functions, the embodiments of the present disclosure are also applicable.

According to some embodiments of the present disclosure, what is provided is the creator of the function based on the machine learning model, while the function is edited, may stores the prompt created in the function editing process as a prompt resource in the prompt library, so that other users may conveniently use the prompt resource when creating other functions. The process of writing a prompt in an editing interface based on an digital assistant or a workflow being edited will be described in detail below with reference to FIGS. 2C-2G.

After providing the creation interface for the prompt creation, the assistant creation platform 110 receives, via the creation interface, the created target prompt and the identification information of the target prompt. In some embodiments, the identification information of the prompt is mainly to identify a prompt to be created currently, and the identification information of the prompt may comprise at least one of a prompt name and description information. The prompt name is to briefly identify the prompt. The description information of the prompt may be used to describe a scenario in which the prompt can be used, for example, whether the prompt is applicable to a character avatar type digital assistant and an efficient tool type digital assistant. The description information of the prompt may also additionally or alternatively introduce a function that can be implemented by the prompt. For example, the description information may indicate that the machine learning model may call certain plug-ins, workflows, databases, knowledge library, etc. based on the prompts. However, this is merely exemplary, which is not limited in the present disclosure. As the example interface 200F shown in FIG. 2F, after adding the prompt 262 to the prompt library, the assistant creation platform 110 may present the name 265 of the prompt 262 and the description information 266 of the prompt.

Accordingly, the creation interface may comprise a first area for prompt input. The body content of the prompt to be created may be inputted via the first area. In addition, the creation interface may further comprise a second area for inputting the prompt name, and/or a third area for inputting the description information.

As the example interface 200B shown in FIG. 2B, the creation interface 220 comprises an area 221 for inputting a prompt name, an area 222 for inputting description information, and an area 223 for inputting a prompt. It may be understood that the assistant creation platform 110 may receive, via the creation interface 220, the name of the prompt inputted by the user 105 in the area 221, the description information of the prompt inputted in the area 222, and the prompt inputted in the area 223.

In some embodiments, if the assistant creation platform 110 receives the confirmation indication, the assistant creation platform 110 adds the received target prompt and the identification information to the prompt library. The prompt library comprises at least one prompt. As shown in FIG. 2B, if the assistant creation platform 110 detects that the user 105 clicks the “confirm” control 224, the assistant creation platform 110 adds the prompt inputted by the user 105 in the area 223, the name of the prompt inputted in the area 221, and the description information for the prompt inputted in the area 222 into the prompt library. In some examples, the prompt library may be presented in a interface 122 by the assistant creation platform 110 for the user 105 to manage the prompts in the prompt library.

In some embodiments, each prompt is selectable to be associated with a function based on a machine learning model-based, the associated prompt being provided as an input of the machine learning model. In some embodiments, as previously mentioned, the function based on the machine learning model may comprise, but is not limited to, a digital assistant, a workflow node in a workflow. That is, the prompt may be associated with the digital assistant 120 based on the machine learning model or workflow node. In this way, the digital assistant or workflow node may process the input of the function by means of a machine learning model and provide the output of the function based on the output of the machine learning model. The prompt can be used to direct the process on the input by the machine learning model to enable to generate the desired output.

In some embodiments, the prompts may comprise setting person, that is, describe a character or responsibility or a reply style played by the digital assistant, and further direct the machine learning model to process the input according to the set character. The prompts may further comprise functions and work processes. That is, describe functions and work processes of the digital assistant, and agree how the digital assistant answers the user's questions in different scenarios. Therefore, the machine learning model is directed to process the input according to the function and the work process. The prompt may also comprise constraints and restrictions, i.e., limit the scope of the digital assistant's reply, e.g., what the digital assistant should answer, what it should not answer. Additionally, the prompt may further comprise specifying a reply format of the digital assistant to cause the digital assistant to answer the user's input in the reply format.

The machine learning model may run at the local server or the remote server of the assistant creation platform 110. In some embodiments, the machine learning model may be based on a language model (LM). The language model can have question-answering capability by learning from a large amount of corpus. The machine learning model may also be based on other suitable models. The configuration of the prompts may be completed by a natural language manner. In this way, the user can conveniently constrain the output of the model, thereby configuring diversified digital assistants. In some embodiments, the machine learning model may also be based on any suitable model structure, including but not limited to a Transformer model, a convolutional neural network (CNN), a recurrent neural network (RNN), a deep neural network (DNN), or the like.

In some embodiments, alternatively or additionally, the prompt may indicate at least one workflow to be performed by the digital assistant 120 to be created. Each workflow may correspond to various operations of the digital assistant 120 when performing a particular function. That is, the user 105 may be allowed to describe how the digital assistant 120 to perform a certain function in a natural language manner. It may be understood that, a function possessed by the machine learning model may be added based on a function of the machine learning model (for example, a workflow node in a digital assistant or a workflow). For example, a digital assistant or workflow node may possess functions such as a calling plug-in, a knowledge library, a database, a trigger, a workflow, and the like. Correspondingly, the use scenarios and descriptions for these functions may be described in the prompts corresponding to the digital assistant or the workflow node.

It should be understood that only some examples of the prompts are given above, and the embodiments of the present disclosure are not limited in this regard. The user may be allowed to freely attempt to create a different prompt to construct a digital assistant whose reply conforms to the user's desire. For example, in a prompt, the user 105 may be allowed to input a request for a reply language of the digital assistant 120, a constraint condition on the reply content of the digital assistant 120 (e.g., the number of words of different types of replies, type of reply content, etc.).

The process of how to deform the prompts in the editing interface of the digital assistant or workflow being edited will be described in detail below with reference to FIGS. 2C-2G. For ease of understanding, the embodiment of the presented disclosure will be described mainly refer to FIGS. 2A-2G and will be described using an example where the prompt are associated with a digital assistant based on a machine learning model.

In some embodiments, the assistant creation platform 110 presents, in the first editing interface of the first function, at least one prompt in the prompt library if a trigger on the prompt library is received. In some examples, the assistant creation platform 110 presents, in the first editing interface corresponding to the digital assistant or the workflow node being edited, at least one prompt in the prompt library if a trigger on the prompt library is received.

The following continues with reference to FIGS. 2C-2D and FIG. 2E to describe how the assistant creation platform 110 receives a trigger on a prompt library.

In some embodiments, the assistant creation platform 110 may receive a trigger on the prompt library based on the first prompt library entry in the first editing interface. As the example interfaces 200C-200D shown in FIGS. 2C-2D, the assistant creation platform 110 presents the example interface 200D comprising a editing interface 241 that corresponds to the digital assistant if the assistant creation platform 110 detects that the user 105 clicks the tuning control 231 for tuning the created digital assistant. In some examples, the assistant creation platform 110 may receive a trigger on the prompt library based on the editing interface 241 comprising the entry 242 of the prompt library.

As the example interface 200E shown in FIG. 2E, if the assistant creation platform 110 detects that the user 105 clicks the workflow node in the workflow that corresponds to the machine learning model, the assistant creation platform 110 presents the detail page 200E corresponding to the workflow node. The assistant creation platform 110 may receive a trigger on the prompt library based on the detail page 200E comprising the entry 250 of the prompt library.

In some embodiments, the assistant creation platform 110 presents at least one prompt in the prompt library if the assistant creation platform 110 receives a trigger on the prompt library. In some embodiments, if a prompt of at least one prompt is selected, the assistant creation platform 110 may present a preview of the selected prompt. As the example interfaces 200E to 200F shown in FIGS. 2E-2F, if the assistant creation platform 110 detects that the user 105 clicks the entry 242 of the prompt library, the assistant creation platform 110 presents the prompt library in the interface 260. Accordingly, the assistant creation platform 110 may also present, in the interface 260, prompts such as AA prompt 262, BB prompt, CC prompt, and the like comprised in the prompt library. In some examples, assistant creation platform 110 may also present identification information, creation time, and the like of the creator of at least one prompt.

In some examples, assistant creation platform 110 may present at least one prompt in the form of a list on the left side of presentation interface 260 by which prompt library is presented. However, this is merely exemplary, which is not limited in the present disclosure. Further, if the assistant creation platform 110 detects that the user 105 clicks the AA prompt 262, the assistant creation platform 110 may present the content of the AA prompt 262 on the right side of the presentation interface 260 of the prompt library, so that the user 105 performs the preview.

In some embodiments, the assistant creation platform 110 may present at least one prompt if the assistant creation platform 110 detects a trigger on the prompt library. Each prompt is classified into at least one of a plurality of types. In some examples, assistant creation platform 110 may display at least one prompt in different types. The type of the prompt may be configured according to various criteria, for example, a part of prompt may be divided into a recommendation type prompt and the other prompts. For example, the assistant creation platform 110 may present at least one prompt recommended for the user, and the assistant creation platform 110 may also present at least one prompt that has been created by the developer and/or the team to which the developer belongs. In some examples, the assistant recommendation platform 110 may present at least one prompt recommended for the user 105 based on the information (e.g., the name of the digital assistant/workflow node) of the digital assistant/workflow node currently being created by the user 105. In some embodiments, the type of the prompt may also be classified based on a scenario where the prompt is used, and/or a function for the prompt. For example, the prompt of the character avatar type may be applicable to a digital assistant or workflow node to generate the character avatar, and the prompt of the efficient type tool may be applied to a digital assistant or workflow node for the efficient tool type. In addition, different prompt types may also be divided for functions (e.g., plug-ins, workflows, databases, knowledge library to be called) being created and the like.

In some embodiments, the assistant creation platform 110 may display at least one prompt comprised in the prompt library according to different types. In some examples, the assistant creation platform 110 may classify the prompts in the prompt library based on a origin (for example, from a team to which the user 105 belongs) of the prompts. In some examples, the assistant creation platform 110 may further divide the prompts in the prompt library into several categories according to the identification information of the prompts. Such classification and presentation manner facilitates the user to quickly locate to a desired prompt.

In some embodiments, if the assistant creation platform 110 receives an application request for the first prompt of the at least one prompt, the assistant creation platform 110 may insert the first prompt into an area of the editing interface corresponding to prompt editing. As the example interfaces 200F and 200D shown in FIG. 2F and FIG. 2D, if the assistant creation platform 110 detects that the user 105 selects the AA prompt 262, the assistant creation platform 110 inserts the AA prompt 262 into the area 243 of the editing interface 241 corresponding to the prompt editing.

Subsequently, the assistant creation platform 110 creates the first function based on at least the first prompt or the edited first prompt. In some examples, assistant creation platform 110 creates a digital assistant 120 or workflow node at least according to AA prompt 262. In other examples, the assistant creation platform 110 may also create the digital assistant 120 or workflow node at least according to edited AA prompt 262. It may be understood that after selecting to insert the AA prompt 262, the user 105 may further write the AA prompt 262 on the basis of the AA prompt 262.

In some embodiments, the first prompt or the edited first prompt can be inputted to a first machine learning model associated with a first function, and the output of the first function is determined based on an output of the first machine learning model. It may be understood that, the AA prompt 262 or the edited AA prompt 262 may be associated with a function (e.g., digital assistant 120 or workflow node) based on the first machine learning model. In this way, the digital assistant 120 or the workflow node may process the input of the function by means of the first machine learning model and provide the output of the function based on the output of the first machine learning model. For example, for a digital assistant based on a machine learning model, the first machine learning model may determine a user demand corresponding to the user input based on the AA prompt 262 or the edited AA prompt 262, and output the user demand, and the output is used to determine a reply to the user.

In some embodiments, in order to enable the user 105 who creates the digital assistant 120 based on the prompt, in the creation process, to conveniently test the running effect of the created digital assistant 120, a tuning area, the tuning area as shown in FIG. 2D, for the digital assistant 120 may also be provided in the example interface 200D. The tuning area 244 comprises an input area 245 for receiving tuning requests for the digital assistant 120, and also comprises a presentation area 246 for providing tuning results for the tuning requests (and providing received tuning requests). The tuning area 244 may be configured as a form of an interactive window, simulating an interactive interface viewed by an interactive user of the digital assistant 120.

The following further describes the management solution of the prompts in the editing process of the digital assistant or the workflow node by referring to FIGS. 2E-2G according to the presented disclosure.

In some embodiments, the assistant creation platform 110 may further present a second editing interface of the second function, and the second editing interface at least comprises the inputted second prompt. As the example interfaces 200E to 200F shown in FIG. 2E to FIG. 2F, in the case that the current prompt for the digital assistant or the workflow node has been edited, the assistant creation platform 110 presents the interface 260 of a prompt library if the assistant creation platform 110 detects that the user 105 clicks the entry 242 of the prompt library.

Further, if the assistant creation platform 110 receives, via the second editing interface of the second function, a resource creation request for the prompt, the assistant creation platform 110 may provide a creation interface for prompt creation, and the creation interface at least comprises an import control. As the example interfaces 200F to 200G shown in FIG. 2F to FIG. 2G, if the assistant creation platform 110 detects that the user 105 clicks the “establish new prompt” control 261 for resource creation comprised by the interface 260 of the prompt library, the assistant creation platform 110 presents the creation interface 270 for the prompt creation. The creation interface 270 comprises an import control 271, an area 272 for inputting a prompt name, an area 273 for inputting description information of the prompt, and the like.

Further, if the assistant creation platform 110 detects a trigger on the import control, the assistant creation platform 110 may insert the second prompt into an area for prompt input of the creation interface. As shown in FIG. 2G, if the assistant creation platform 110 detects that the user 105 clicks the import control 271, the assistant creation platform 110 may insert the currently edited prompt into the area 274 for prompt input of the creation interface 270. In some examples, the user 105 may also write the second prompt in area 274. Then, if the assistant creation platform 110 detects that the user 105 clicks the “confirm” control, the assistant creation platform 110 adds the current prompt and the name and description information of the prompt to the prompt library.

In some embodiments, at least one of the application, editing, and deletion of the prompt in the prompt library is based on a character of the user. It may be understood that, the prompt in the prompt library may be copied or directly used into the digital assistant or the workflow node according to the character of the user. Accordingly, the prompts in the prompt library may also be edited, deleted, and the like according to the character of the user. For example, for the creator (for example, the user 105) of the prompt, the prompts in the prompt library may be edited, deleted, and the like. For other users belonging to the same organization/team/workspace with the user 105, the prompts in the prompt library may be accessed, applied, and copied. In some embodiments, the creator of the prompt may configure which user may has the ability to access, apply, and/or copy the prompt, or may configure the user's ability to access, apply, and/or copy the respective prompt based on a default policy.

In summary, according to the embodiments of the present disclosure, by storing the prompts in the prompt library, the user can conveniently and quickly reuse the prompts. Therefore, the digital assistant or workflow node based on the machine learning model with different functions is quickly created.

In some embodiments, in the process of editing the prompt, for example, in a process of creating a new prompt in the prompt library or in a process of editing a specific function (for example, a digital assistant or a workflow node), an edit block function on the prompt may be provided. If the prompt comprises an edit block, when the prompt is reused or edited, the user may re-create a new prompt content in the provided edit block. In the process of editing the digital assistant or the workflow node, the user may edit, in the edit block, the prompt content corresponding to the digital assistant or the workflow node. In some embodiments, in a scenario in which an edit block exists for the prompt resource, the user 105 may edit the content contained in the prompt. Alternatively, the user may edit the content contained in the edit block in the prompt. In some examples, the content contained in the edit block may be provided to a user (e.g., developer) using the prompt resource in the form of a form to be filled.

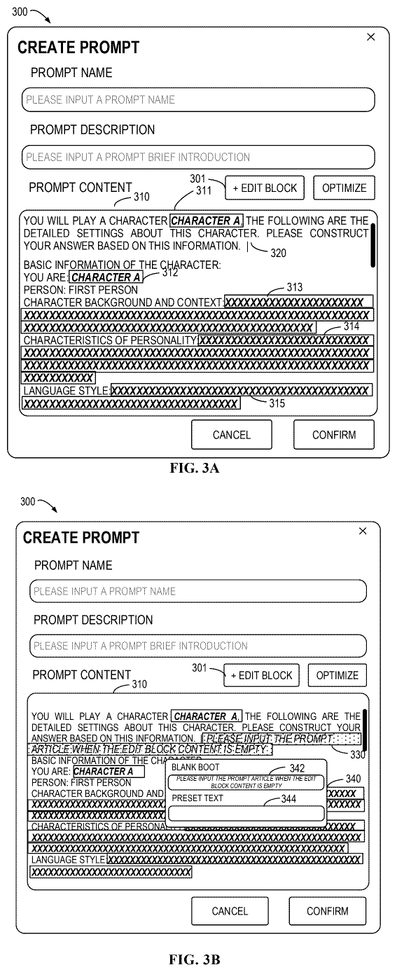

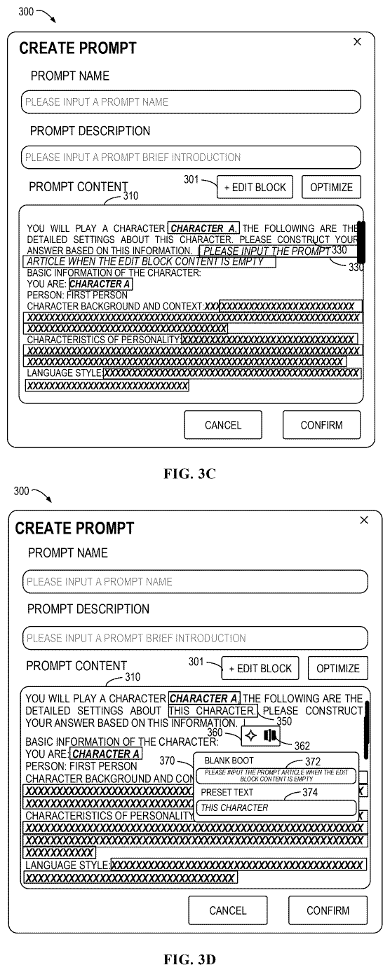

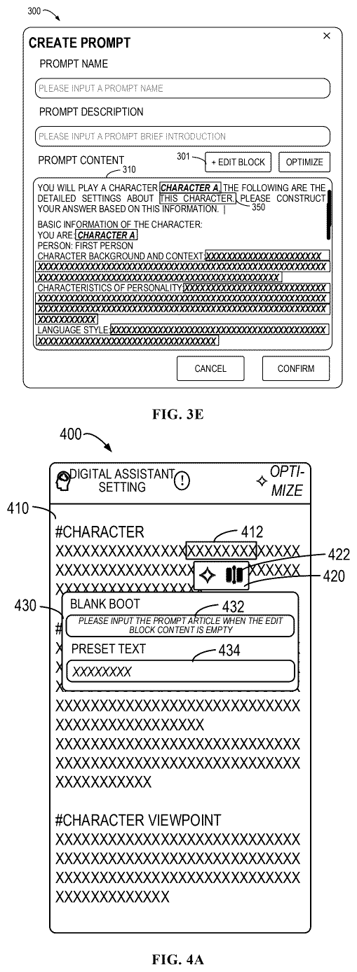

This edit block function will be described below in conjunction with FIGS. 3A-6. FIGS. 3A-6 show schematic diagrams of example interfaces 300 to 600 for creating a new prompt or editing a specific function according to some embodiments of the present disclosure.

In some embodiments, to facilitate the user to intuitively recognize the edit block, the assistant creation platform 110 may present the edit block or the content in the edit block and the content of the non-edit block in the prompt in different visual styles. Referring to FIG. 3A, FIGS. 3A-3E show an example 300 of an editing interface for writing a prompt for a prompt library according to some embodiments of the present disclosure. The example 300 comprises an area 310 for editing prompt content, which may present a content of the prompt. It should be noted that, here, only prompts (including edit blocks and non-edit blocks) comprising only text are used for example description, and when it comes to the actual application, the prompt may comprise any suitable type of content such as an image and a code. Different content may correspond to different types of edit blocks. For example, the text content may correspond to a text edit block, the image content may correspond to an image edit block, the API description may correspond to an API edit block, and so on. The triggering manners, the creation manners, and the like of different types of edit blocks may be the same or different.

Specifically, the area 310 may presented a content with at least one edit block (for example, the edit block 311, the edit block 312, the edit block 313, the edit block 314, and the edit block 315) and a non-edit block (for example, the text “you will play a character”, the text “the following are the detailed settings about this character, please construct your answer based on this information”, the text “basic information of the character”, the text “character underground and context”, etc. as shown in the figure). The assistant creation platform 110 may present the content of the non-edit blocks in a visual style of regular text, and may present the edit blocks in a visual style such as bolding, tilting, different colors, different fonts, and/or adding borders. It should be understood that the presentation of the visual style of the edit block in the figure is merely an example, and the visual style to be used is selectable according to actual needs.

The assistant creation platform 110 may present input cursor 320 and add control 301 for a text edit block in area 310. In the case of without receiving a selection of at least part of the text of the prompt, the assistant creation platform 110 may determine that a trigger on the text edit block function is detected if a trigger on the adding control 301 is received (e.g., clicking the adding control 301). The assistant creation platform 110 may present the editing interface shown in FIG. 3B.

In FIG. 3B, the assistant creation platform 110 may present inserted text edit block 330 at input cursor 320. In some embodiments, the assistant creation platform 110 may also display the filling guidance text in association with the text edit block 330 (for example, the text “Please input the prompt text when the edit block content is empty” displayed in the text edit block 330 as shown in the figure). The assistant creation platform 110 may also present a text input interface 340 for the text edit block 330 in association with the text edit block 330. Text input interface 340 comprises at least one of input area 342 and input area 344.

In some embodiments, when the text input interface 340 is presented in association with the text edit block 330, it may be determined that the text edit block 330 is in a text editing state, and when the text input interface 340 is not presented, it may be determined that the text edit block 330 is not in the text editing state. The assistant creation platform 110 may present the text edit block 330 in the text editing state and the text edit block 330 not in the text editing state in different visual styles. As an example, referring also to FIG. 3C, the assistant creation platform 110 may present text edit block 330 in a different visual style in FIG. 3B and FIG. 3C.

With continued reference to the editing interface shown in FIG. 3D, in some embodiments, if the assistant creation platform 110 detects that the text “this character” of the non-edit block in the prompt is selected, the assistant creation platform 110 may directly present a window 360 comprising at least one operation control. At least one control in the window 360 comprises at least an editing control 362. In response to the editing control 362 being triggered, the assistant creation platform 110 may configure the text edit block 350 based on the text “this character” the text and the text edit block 350 is filled with the text ‘this character’.

In some embodiments, assistant creation platform 110 may also present text input interface 370 for text edit block 350 in association with the text edit block 350. The text input interface 370 comprises at least one of input area 372 and input area 374. Similarly, the assistant creation platform 110 may fill the guide text for display when no text was filled in the given text edit block if the assistant creation platform 110 receives a filling guide text for the given text edit block at the input area 372. The assistant creation platform 110 may replace the text (e.g., “this character”) already filled in the given text edit block with a specified text if the assistant creation platform 110 receives the specified text at the input area 374.

Similarly, in the case of without receiving the specified text inputted by the user via the input area 374, the assistant creation platform 110 may present, in the text edit block 350, the guide text in the input area 372. In the case of receiving the specified text inputted via the input area 374, the assistant creation platform 110 preferentially presents the specified text in the text edit block 350.

Similarly, when the text input interface 370 is presented in association with the text edit block 350, it may be determined that the text edit block 350 is in a text editing state, and when the text input interface 370 is not presented, it may be determined that the text edit block 350 is not in the text editing state. The assistant creation platform 110 may present the text edit block 350 in the text editing state and the text edit block 350 not in the text editing state with different visual styles. As an example, referring also to FIG. 3E, the assistant creation platform 110 may present text edit block 350 in different visual styles in FIG. 3D and FIG. 3E.

The assistant creation platform 110 may determine the content filled in the edit block as a part of the prompt in response to a confirmation of the editing of the prompt. For example, referring to the example 300 shown in FIGS. 3A-3E, the example 300 may comprise a confirmation control for the prompt. For example, if the assistant creation platform 110 receives the trigger on the confirmation control, the assistant creation platform 110 may determine the content filled in the edit block as a part of the prompt.

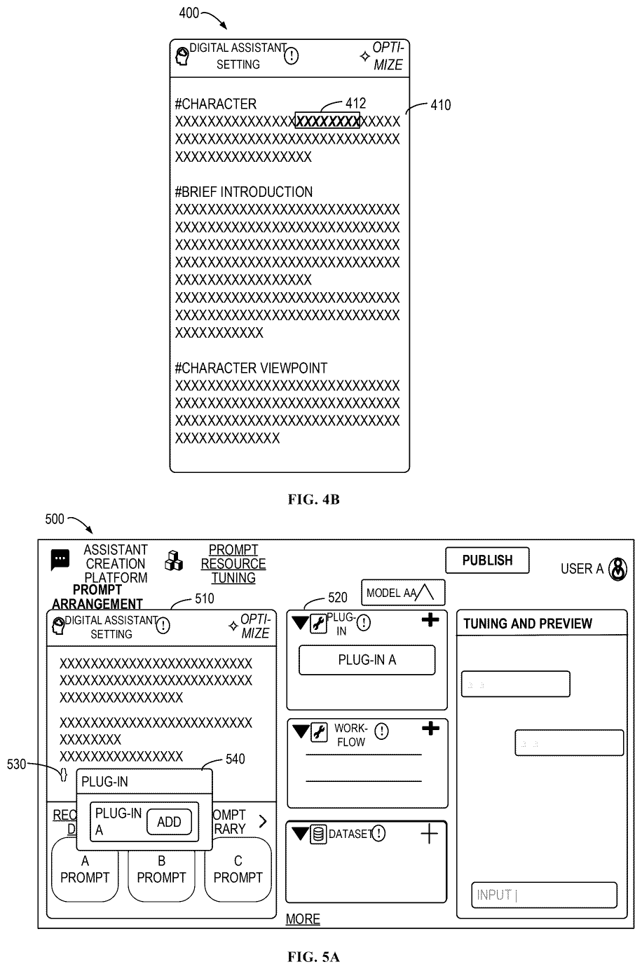

With continued reference to FIG. 4A and FIG. 4B, if the assistant creation platform 110 detects the trigger on the text edit block function when at least a part of the text of the prompt is selected, the assistant creation platform 110 may configure, at the position of the selected at least part of the text, the text edit block based on at least a part of the text. The at least a part of the text may be filled in the text edit block herein. FIG. 4A and FIG. 4B show the example 400 of an editing interface for a target function according to some embodiments of the present disclosure. A prompt is presented in an area 410 of example 400.

Referring to the editing interface shown in FIG. 4A, in some embodiments, if the assistant creation platform 110 detects that the text “XXXXXXXX” of the non-edit block in the prompt is selected, the assistant creation platform 110 may directly present a window 420 comprising at least one operation control. At least one control in the window 420 at least comprises an editing control 422. If the assistant creation platform 110 detects that the editing control 422 is triggered, the assistant creation platform 110 may configure the text edit block 412 according to the selected text, and the text edit block 412 is filled with the selected text “XXXXXXXX”.

In some embodiments, the assistant creation platform 110 may also present text input interface 430 for text edit block 412 in association with text edit block 412. The text input interface 430 comprises at least one of an input area 432 (which, for example, may be referred to a second input area corresponding to the text edit block 412) and an input area 434 (which, for example, may be referred to a first input area corresponding to the text edit block 412). The selected text “XXXXXXXX” may be presented by default in the input area 434.

Similarly, when the text input interface 430 is presented in association with the text edit block 412, it may be determined that the text edit block 412 is in a text editing state, and when the text input interface 430 is not presented, it may be determined that the text edit block 412 is not in the text editing state. The assistant creation platform 110 may present the text edit block 412 in the text editing state and the text edit block 412 not in the text editing state in different visual styles. As an example, assistant creation platform 110 may present text edit block 412 in different visual styles in FIG. 4A and in FIG. 4B.

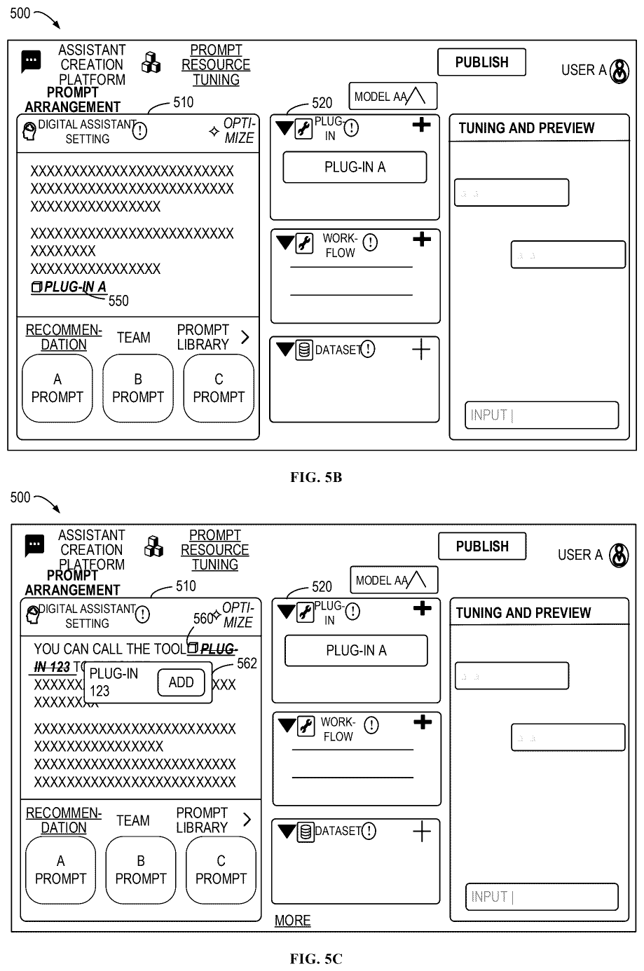

With continuing reference to FIGS. 5A-5D, the assistant creation platform 110 may insert an API edit block at a selected location of the prompt if the assistant creation platform 110 detects a trigger on an application program interface (API) edit block function. In some examples, the API edit block can be filled with identification information of a predefined API, and the identification information of the API may comprise any suitable information such as a name of the API, an image identifier, a brief description, and the like. FIG. 5A to FIG. 5D show an example 500 of an editing interface for a target function according to some further embodiments of the present disclosure.

Referring to FIG. 5A, in example 500, in response to receiving, at a configuration area 510, a predetermined symbol 530 (e.g., brackets {}) inputted by the user, the assistant creation platform 110 may detect a trigger on an API edit block function. In this case, the assistant creation platform 110 may determine that a trigger on the API edit block is detected, and insert the API edit block at predetermined symbol 530.

In some examples, the assistant creation platform 110 may present, at an area 520 in an interface 500, at least one API (e.g., plugin A) associated with the target function. The assistant creation platform 110 may present a window 540 at a predetermined symbol 530. The window 540 may present identification information of the plug-in A and an adding control for the plug-in A. Subsequently, in the example 500 shown in FIG. 5B, if the assistant creation platform 110 receives, in the window 540, a trigger on an adding control for the plug-in A, the assistant creation platform 110 may fill the identification information of the plug-in A into an API edit block 550.

With continued reference to FIG. 5C, the prompt comprises an API edit block 560, and because an API (i.e., plug-in 123) is not associated with a target function, the assistant creation platform 110 may present the identification information of the plug-in 123 as the visual style corresponding to the disabled state by overlay presenting a deletion line on the API edit block. The visual style corresponding to the disabled state may be, for example, setting to gray, but this is merely exemplary, which is not limited in the present disclosure. Further, if the assistant creation platform 110 detects a trigger on the API edit block 560, the assistant creation platform 110 presents a window 562. The window 562 presents a fillable plug-in 123 and an adding control for the plug-in 123. In the example 500 shown in FIGS. 5C-5D, if the assistant creation platform 110 receives a trigger on an adding control for the plug-in 123, the assistant creation platform 110 may associate the plug-in 123 with the target function. The assistant creation platform 110 may present the plug-in 123 in the area 520. Now the plug-in 123 associated with the target function is switched to an enabled state at this time. The assistant creation platform 110 may also present the identification information of the plug-in 123 as a visual style corresponding to the enabled state by canceling the presentation of the deletion line.

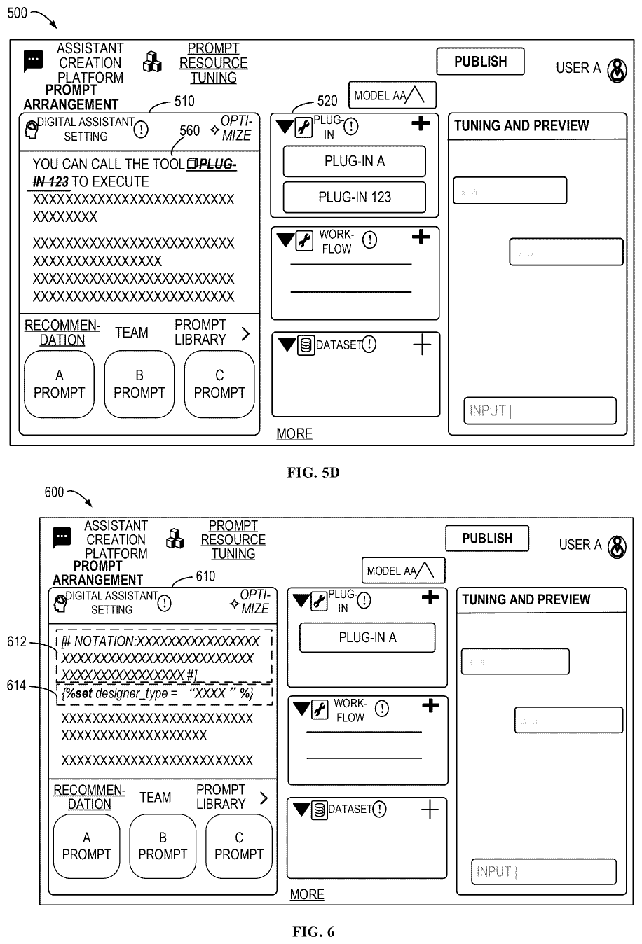

With continued reference to FIG. 6, if the assistant creation platform 110 determine that a part of content inputted in the editing interface is marked as an annotation content, the assistant creation platform 110 may present the annotation content in different visual styles. The annotation content here will not be inputted to a machine learning model. FIG. 6 shows an example 600 of an editing interface according to some embodiments of the present disclosure. The example 600 shown in FIG. 6 comprises an area 610 that presents a prompt. If the assistant creation platform 110 determine that the content 612 is identified as an annotation content, the assistant creation platform 110 may present, in the area 610, the annotation content in a visual style such as an inclined text, a gray font, etc . . . . In other examples, the assistant creation platform 110 may present the symbol “%” in content 614 and the “set” in the code in a bold visual style if the assistant creation platform 110 determine that the content 614 is a computer language code.

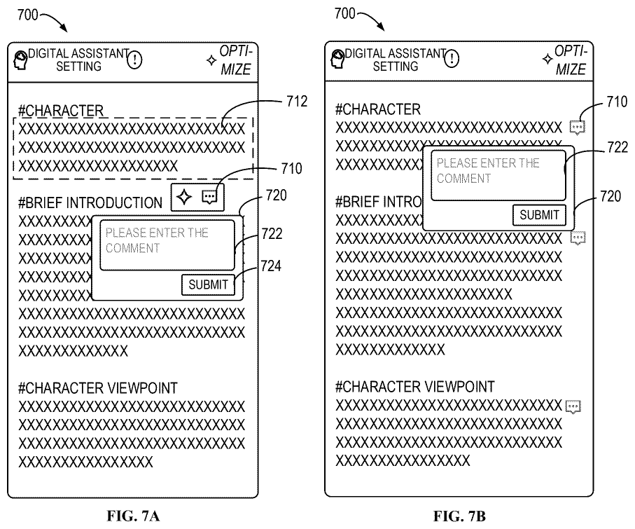

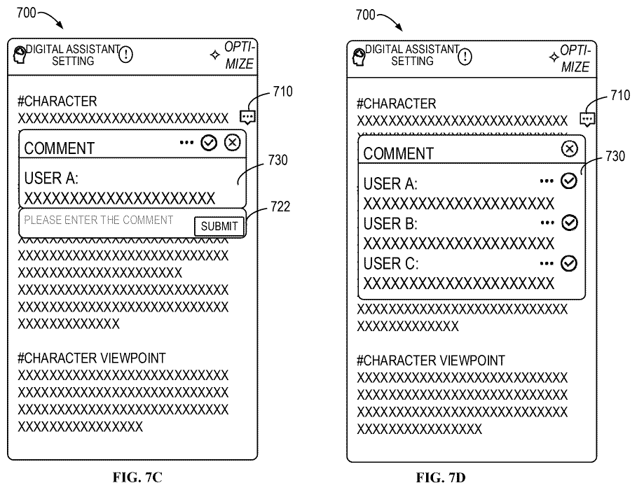

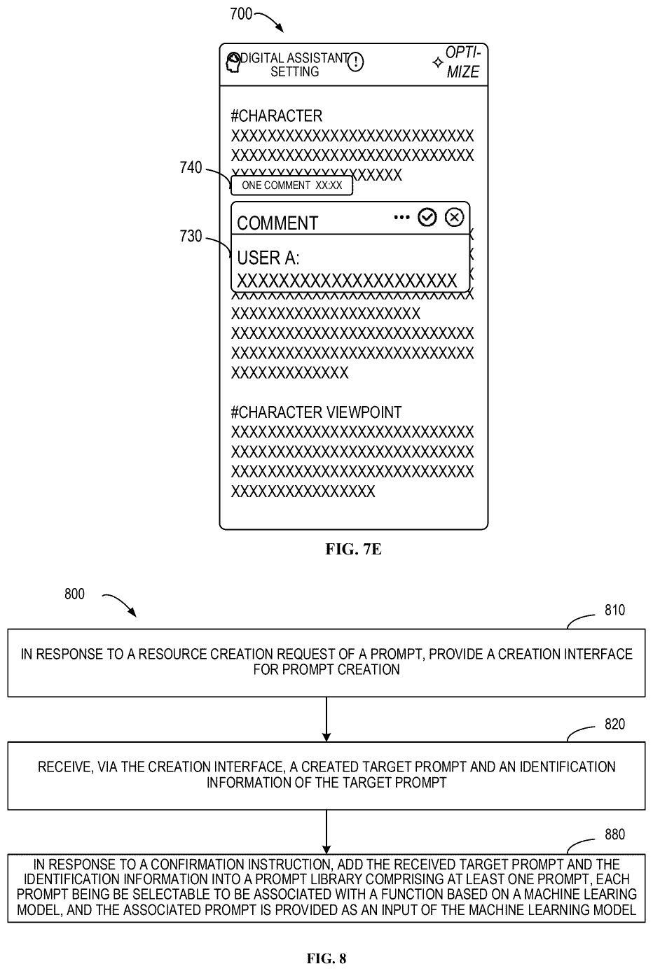

In some embodiments, for the prompt area in the editing interface based on the function of the prompt, a comment function for the prompt may be further provided. For example, in an editing interface for a prompt in a prompt library, or in an editing interface for a specific function (for example, a digital assistant or a workflow node), a comment function for the prompt may be provided. This is because different users may develop and maintain the same function, providing a comment function helps the users share the comments on the prompts, provide annotations on the prompts, and help the user better understand the function of the prompts. FIGS. 7A-7E show an example interface 700 for a comment function for a prompt according to some embodiments of the present disclosure. The comment function here is sometimes also referred to as an annotation function. FIGS. 7A-7E show providing a comment function for a prompt in a prompt input area for a digital assistant. It should be understood that, in a process of editing a prompt of another function (for example, a workflow node), or in a process of adding a new prompt to the prompt library, or when the prompt in the prompt library is viewed, a comment function for the prompt may be provided.

In some embodiments, in response to a trigger on a comment for at least a part of the content of the prompt, assistant creation platform 110 presents a user interface for the comment input. In some embodiments, in response to at least a portion of the content of the prompt being selected, a comment control is presented, and in response to a trigger for the comment control, a user interface for the comment input is presented. The user interface for the comment input comprises an input control. The input control for comment input may comprise input boxes, or may also comprise one or more other input controls that support voice input, image input, file import, and the like. Comments for the selected at least a part of the content may be received via an input control, such as an input box.

As shown in FIG. 7A, in the prompt input area of the digital assistant, in response to a part of content 712 in the prompt being selected, a panel of operable controls may be presented, where at least a comment control 712 is provided. In response to a trigger for the comment control 710 is detected, a user interface 720 for comment input is presented. The user interface 720 comprising an input box 722. The user may input a comment content for a part of content 712 in the input box 722. In response to a confirmation of the comment content is detected, for example, a trigger (or a confirmation triggered in other ways) on the “submit” control 724 in FIG. 7A, the received comment content may be associated with the selected part of content 712.

In some embodiments, the comment control for triggering the comment function may be presented in association with a unit content of the prompt, for example, the comment control may be presented in association at each paragraph or each row of the prompt content. As shown in FIG. 7B, a comment control 710 is presented at each paragraph of the prompt. The comment control may be presented in a fixed manner or may be presented after a hover operation on the portion (e.g., mouse hover over the portion of content) is detected. Similar to the example of FIG. 7B, by triggering the comment control, a user interface for comment input may be presented for the user to input the comment content.

In some embodiments, the comment function of the prompt may be determined based on the character of the user. For example, a creator of the prompt in the digital assistant, the workflow node, or the prompt library can add a comment to the prompt, and can configure a range of users who can comment on the corresponding prompt.

In some embodiments, comments associated with at least a part of the prompts may be presented to the user. In some embodiments, comments associated with at least a part of the prompts may be fixedly presented in a particular comment display area. In some embodiments, the comment associated with at least a part of the content in the prompt may be in a stowed state and expanded for presentation to the user after a detection of a trigger on a review of the comment. As shown in FIG. 7C, the comment panel 730 may be presented by clicking on the comment control 710 or by a hover operation over the comment control 710, where a comment on the associated prompt content is presented. In some embodiments, if there are multiple comments on at least a part of the content of the prompt, the comment may also be presented in a stowed state, and the comment may be presented to the user after the stowed state being triggered. As shown in FIG. 7D, after the comment control 710 is triggered, a plurality of comments may be presented in the comment panel 730. In some embodiments, a similar comment control for triggering comment input or other comment input triggering manner may be provided in the comment panel, to trigger the input control for presenting the comment. As shown in FIG. 7C, the input box 722 of the comment may also be presented while other comments are presented, so that the current user inputs the comment content.

In some embodiments, when the comment is in the stowed state, a comment summary information for a certain content part in the prompt may also be provided. The comment summary information may indicate the number of comments, identifications of at least a part of users sending comments, a part of content of comments, and the like. In this way, in the case that the comment details are not expanded, the user can know that a certain part of the prompt has comments, and can know at least a part of the information of the comment. As shown in FIG. 7E, a comment viewing control 740 is provided at the portion of commenting a prompt associated. By triggering the comment viewing control 740, a comment panel 730 may be presented in which a comment of the associated prompt content is presented.

In some embodiments, the presentation of the comment may also be determined based on the character of the user. For example, a user capable of accessing the prompt may be configured to be able to access a comment related to the prompt. In some embodiments, an edition, comprising modification, deletion, and the like of the comment content, to an existing comment in the prompt may also be supported. The editing function for the comment may also be determined based on the character of the user. For example, a user with an editing capability for the prompt may be configured, and an editing function for the comment is also supported.

In some embodiments, in the prompt editing process, the annotation content and the comment associated with the prompt will not be used to construct the prompt inputted to a machine learning model. In some embodiments, in the case of creating a digital assistant or workflow, the annotation content/comment is added, so that other developers of the digital assistant or workflow can quickly understand the logic of the prompt, thereby improving development efficiency. Further, after the prompt added with the comment content/comment is saved in the prompt library, the other developer can quickly understand the logic of the prompt when the prompt is reused.

FIG. 8 shows a flowchart of a process 800 for prompt management according to some embodiments of the present disclosure. The process 800 may be implemented at the assistant creation platform 110. The process 800 is described below with reference to FIG. 1.

At block 810, in response to a resource creation request of a prompt, the assistant creation platform 110 provides a creation interface for prompt creation.

At block 820, the assistant creation platform 110 receives, via the creation interface, a created target prompt and an identification information of the target prompt.

In block 830, in response to a confirmation indication, the assistant creation platform 110 adds the received target prompt and the identification information into a prompt library comprising at least one prompt, each prompt may be selectable to be associated with a function machine learning model, and the associated prompt is provided as an input of the machine learning model.

In some embodiments, the process 800 further comprises: in response to a trigger on the prompt library, presenting, in a first editing interface of a first function, the at least one prompt in the prompt library; in response to an application request for a first prompt of the at least one prompt, inserting the first prompt into an area of the editing interface corresponding to prompt editing; and creating the first function based on at least the first prompt or the edited first prompt, the first prompt or the edited first prompt being able to be inputted to a first machine learning model associated with the first function, and an output of the first function being determined based on an output of the first machine learning model.

In some embodiments, presenting the at least one prompt comprises: in response to a trigger on the prompt library, presenting the at least one prompt; and in response to a prompt of the at least one prompt being selected, presenting a preview of the selected prompt.

In some embodiments, presenting the at least one prompt comprises: in response to a trigger on the prompt library, presenting the at least one prompt by type, wherein each prompt is classified into at least one of a plurality of types.

In some embodiments, the trigger on the prompt library is initiated via: a trigger on a first prompt library entry in the first editing interface; a type selection on a prompt resource in a resource adding interface.

In some embodiments, providing the creation interface for prompt creation comprises: presenting a second editing interface of a second function, the second editing interface at least comprising an inputted second prompt; in response to receiving a resource creation request for a prompt via the second editing interface of the second function, providing the creation interface for prompt creation, the creation interface at least comprising an import control; and in response to detecting a trigger on the import control, inserting the second prompt into an area of the creation interface configured for prompt input.

In some embodiments, a permission for at least one of applying, editing, or deleting a prompt in the prompt library is based on a character of a user.

In some embodiments, the identification information comprises at least one of a prompt name or description information, and wherein the creation interface at least comprises a first area for prompt input, and the creation interface further comprises at least one of the following: a second area for inputting a prompt name, or a third area for inputting description information.

In some embodiments, the function based on the machine learning model comprises at least one of the following: a digital assistant, a workflow node in a workflow.

Embodiments of the present disclosure also provide a corresponding apparatus for implementing the above method or process. FIG. 8 shows a schematic structural block diagram of an apparatus 800 for prompt management according to some embodiments of the present disclosure. The apparatus 800 may be, for example, implemented in or comprised in the assistant creation platform 110. The various modules/components in the apparatus 800 may be implemented by hardware, software, firmware, or any combination thereof.

As shown in the figure, an apparatus 900 comprises a creation interface providing module, configured to provide, in response to a resource creation request of a prompt, a creation interface for prompt creation. The apparatus 900 further comprises a receiving module, configured to receive, via the creation interface, a created target prompt and identification information of the target prompt. The apparatus 900 further comprises an adding module, configured to add, in response to a confirmation indication, the received target prompt and the identification information into a prompt library, the prompt library comprising at least one prompt, each prompt being selectable to be associated with a function based on a machine learning model, and the associated prompt being provided as an input of the machine learning model.

In some embodiments, the apparatus 900 further comprises a function creation module configured to, in response to a trigger on the prompt library, presenting, in a first editing interface of a first function, the at least one prompt in the prompt library; in response to an application request for a first prompt of the at least one prompt, inserting the first prompt into an area of the editing interface corresponding to prompt editing; and creating the first function based on at least the first prompt or the edited first prompt, the first prompt or the edited first prompt being able to be inputted to a first machine learning model associated with the first function, and an output of the first function being determined based on an output of the first machine learning model.

In some embodiments, the apparatus 900 further comprises a presenting module configured to, in response to a trigger on the prompt library, presenting the at least one prompt; and in response to a prompt of the at least one prompt being selected, presenting a preview of the selected prompt.

In some embodiments, the presenting module is further configured to, in response to a trigger on the prompt library, presenting the at least one prompt by type, wherein each prompt is classified into at least one of a plurality of types.

In some embodiments, the trigger on the prompt library is initiated via: a trigger on a first prompt library entry in the first editing interface; a type selection on a prompt resource in a resource adding interface.

In some embodiments, the creation interface providing module 910 is further configured to, presenting a second editing interface of a second function, the second editing interface at least comprising an inputted second prompt; in response to receiving a resource creation request for a prompt via the second editing interface of the second function, providing the creation interface for prompt creation, the creation interface at least comprising an import control; and in response to detecting a trigger on the import control, inserting the second prompt into an area of the creation interface configured for prompt input.

In some embodiments, a permission for at least one of applying, editing, or deleting a prompt in the prompt library is based on a character of a user.

In some embodiments, the identification information comprises at least one of a prompt name or description information, and wherein the creation interface at least comprises a first area for prompt input, and the creation interface further comprises at least one of the following: a second area for inputting a prompt name, or a third area for inputting description information.

In some embodiments, the function based on the machine learning model comprises at least one of the following: a digital assistant, a workflow node in a workflow.

The units and/or modules comprised in the apparatus 900 may be implemented in various forms, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 900 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

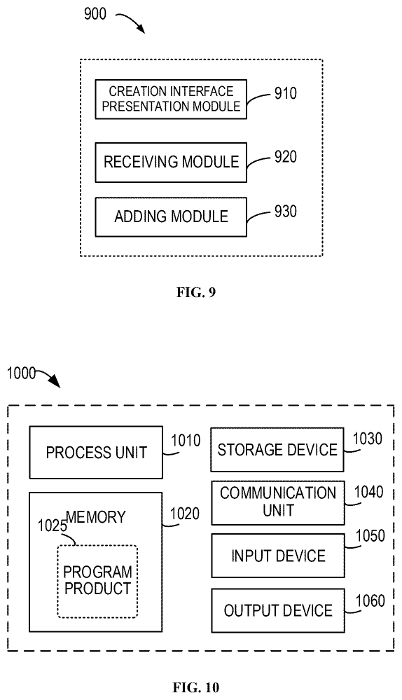

FIG. 10 shows a block diagram of an electronic device 1000 capable of implementing one or more embodiments of the present disclosure. It should be understood that the electronic device 1000 shown in FIG. 10 is merely for example and should not constitute any limitation on the function and scope of the embodiments described herein. The electronic device 1000 shown in FIG. 10 may comprise or may be implemented as the assistant creation platform 110 of FIG. 1 or the apparatus 900 of FIG. 9.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In multiprocessor systems, multiple processing units execute computer-executable instructions in parallel to improve parallel processing capabilities of electronic device 1000.

The electronic device 1000 typically includes a plurality of computer storage media. Such media may be any available media accessible by the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1030 may be a removable or non-removable medium and may include a machine-readable medium, such as a flash drive, magnetic disk, or any other medium, which may be capable of storing information and/or data (for example, the training data for training) and may be accessed within electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments of the disclosure.

The communications unit 1040 implements communications with other electronic devices over a communications medium. Additionally, the functionality of components of the electronic device 1000 may be implemented in a single computing cluster or multiple computing machines capable of communicating over a communication connection. Thus, the electronic device 1000 may operate in a networked environment using logical connections with one or more other servers, network personal computers (PCs), or another network node.

The input device 1050 may be one or more input devices, such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc., communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

What is claimed is:

1. A method for prompt management, comprising:
in response to a resource creation request of a prompt, providing a creation interface for prompt creation;
receiving, via the creation interface, a target prompt created using the creation interface and identification information of the target prompt; and
in response to a confirmation indication, adding the target prompt and the identification information into a prompt library, the prompt library comprising at least one prompt, each of the at least one prompt being selectable to be associated with a function based on a machine learning model, and the each of the at least one prompt being provided as an input of the machine learning model.

2. The method of claim 1, further comprising:
in response to a trigger on the prompt library, presenting, in a first editing interface of a first function, the at least one prompt in the prompt library;
in response to an application request for a first prompt of the at least one prompt, inserting the first prompt into an area of an editing interface, wherein the area of the editing interface is corresponding to prompt editing; and
creating the first function based on at least the first prompt or an edited first prompt, the first prompt or the edited first prompt being able to be inputted to a first machine learning model associated with the first function, and an output of the first function being determined based on an output of the first machine learning model.

3. The method of claim 2, wherein presenting the at least one prompt comprises:
in response to the trigger on the prompt library, presenting the at least one prompt; and
in response to a prompt of the at least one prompt being selected, presenting a preview of the selected prompt.

4. The method of claim 2, wherein presenting the at least one prompt comprises:
in response to the trigger on the prompt library, presenting the at least one prompt by type, wherein each of the at least one prompt is classified into at least one of a plurality of types.

5. The method of claim 2, wherein the trigger on the prompt library is initiated via:
a trigger on a first prompt library entry in the first editing interface; or
a type selection on a prompt resource in a resource adding interface.

6. The method of claim 1, wherein providing the creation interface for prompt creation comprises:
presenting a second editing interface of a second function, the second editing interface at least comprising a second prompt;
in response to receiving a resource creation request for a prompt via the second editing interface of the second function, providing the creation interface for prompt creation, the creation interface at least comprising an import control; and
in response to detecting a trigger on the import control, inserting the second prompt into an area of the creation interface configured for prompt input.

7. The method of claim 1, wherein a permission for at least one of applying, editing, or deleting a prompt in the prompt library is based on a character of a user.

8. The method of claim 1, wherein the identification information comprises at least one of a prompt name or description information, and
wherein the creation interface at least comprises a first area for prompt input, and the creation interface further comprises at least one of the following: a second area for inputting a prompt name or a third area for inputting description information.

9. The method of claim 1, wherein the function based on the machine learning model comprises at least one of the following: a digital assistant or a workflow node in a workflow.

10. A device, comprising:
at least one processor; and
at least one memory coupled to the at least one processor and storing instructions for execution by the at least one processor, the instructions, when executed by the at least one processor, causing the device to perform operations comprising:
in response to a resource creation request of a prompt, providing a creation interface for prompt creation;
receiving, via the creation interface, a target prompt created using the creation interface and identification information of the target prompt; and
in response to a confirmation indication, adding the target prompt and the identification information into a prompt library, the prompt library comprising at least one prompt, each of the at least one prompt being selectable to be associated with a function based on a machine learning model, and the each of the at least one prompt being provided as an input of the machine learning model.

11. The device of claim 10, wherein the operations further comprise:
in response to a trigger on the prompt library, presenting, in a first editing interface of a first function, the at least one prompt in the prompt library;
in response to an application request for a first prompt of the at least one prompt, inserting the first prompt into an area of an editing interface, wherein the area of the editing interface is corresponding to prompt editing; and
creating the first function based on at least the first prompt or an edited first prompt, the first prompt or the edited first prompt being able to be inputted to a first machine learning model associated with the first function, and an output of the first function being determined based on an output of the first machine learning model.

12. The device of claim 11, wherein presenting the at least one prompt comprises:
in response to the trigger on the prompt library, presenting the at least one prompt; and
in response to a prompt of the at least one prompt being selected, presenting a preview of the selected prompt.

13. The device of claim 11, wherein presenting the at least one prompt comprises:
in response to the trigger on the prompt library, presenting the at least one prompt by type, wherein each of the at least one prompt is classified into at least one of a plurality of types.

14. The device of claim 11, wherein the trigger on the prompt library is initiated via:
a trigger on a first prompt library entry in the first editing interface; or
a type selection on a prompt resource in a resource adding interface.

15. The device of claim 10, wherein providing the creation interface for prompt creation comprises:
presenting a second editing interface of a second function, the second editing interface at least comprising a second prompt;
in response to receiving a resource creation request for a prompt via the second editing interface of the second function, providing the creation interface for prompt creation, the creation interface at least comprising an import control; and
in response to detecting a trigger on the import control, inserting the second prompt into an area of the creation interface configured for prompt input.

16. The device of claim 10, wherein a permission for at least one of applying, editing, or deleting a prompt in the prompt library is based on a character of a user.

17. The device of claim 10, wherein the identification information comprises at least one of a prompt name or description information, and
wherein the creation interface at least comprises a first area for prompt input, and the creation interface further comprises at least one of the following: a second area for inputting a prompt name or a third area for inputting description information.

18. The device of claim 10, wherein the function based on the machine learning model comprises at least one of the following: a digital assistant, or a workflow node in a workflow.

19. A non-transitory computer-readable storage medium having a computer program stored thereon, the computer program being executable by at least one processor to perform operations comprising:
in response to a resource creation request of a prompt, providing a creation interface for prompt creation;
receiving, via the creation interface, a target prompt created using the creation interface and identification information of the target prompt; and
in response to a confirmation indication, adding the target prompt and the identification information into a prompt library, the prompt library comprising at least one prompt, each of the at least one prompt being selectable to be associated with a function based on a machine learning model, and the each of at least one prompt being provided as an input of the machine learning model.

20. The non-transitory computer-readable storage medium of claim 19, wherein the operations further comprise:
in response to a trigger on the prompt library, presenting, in a first editing interface of a first function, the at least one prompt in the prompt library;
in response to an application request for a first prompt of the at least one prompt, inserting the first prompt into an area of an editing interface, wherein the area of the editing interface is corresponding to prompt editing; and
creating the first function based on at least the first prompt or an edited first prompt, the first prompt or the edited first prompt being able to be inputted to a first machine learning model associated with the first function, and an output of the first function being determined based on an output of the first machine learning model.
